(19) United States
(12) Patent Application Publication
(10) Pub. No.: US 2026/0147770 A1
(43) Pub. Date: May 28, 2026

(54) GENETIC RECIPROCAL RANK FUSION: A METHOD FOR COMBINING GENETIC ALGORITHM AND RANK FUSION FOR RERANKING IN RAG APPLICATIONS

(71) Applicant: Dell Products L.P., Round Rock, TX (US)

(72) Inventors: Karen Braga Enes, Belo Horizonte (BR); Karen Stéfany Martins Zuin, Belo Horizonte (BR); Juarez Monteiro dos Santos Júnior, Cidreira (BR); Isabella Costa Maia, Bertioga (BR); Pablo Nascimento da Silva, Niterói (BR)

(21) Appl. No.: 18/962,896

(22) Filed: Nov. 27, 2024

(51) Int. Cl. G06F 16/2457; G06F 16/2455

(52) U.S. Cl. CPC G06F 16/24578; G06F 16/2455

(57) ABSTRACT

One example method includes receiving a set of reranking models, and a dataset that comprises questions posed by a user, and also comprises expected source documents responsive to the questions, using the set of reranking models, and the dataset, to identify a best combination set of reranking models, using the set of reranking models, and the dataset to determine best respective weights for each of the reranking models, using, in a RAG (retrieval-augmented generation) pipeline, the best combination set of reranking models, and the best respective weights for each of the reranking models, to rank documents, collectively identified by the reranking models, to the questions, and one or more best documents, from among the documents, are ranked highest, and returning the best documents to the user.

### COPYRIGHT AND MASK WORK NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyrights rights whatsoever.

### TECHNOLOGICAL FIELD OF THE DISCLOSURE

Embodiments disclosed herein generally relate to identification and retrieval of information, such as in response to user queries. More particularly, at least some embodiments relate to systems, hardware, software, computer-readable media, and methods, for re-ranking documents retrieved, or otherwise obtained, in response to a user query.

### BACKGROUND

Retrieval-Augmented Generation (RAG) is a promising approach for mitigating many of the LLM (large language model) challenges and limitations such as hallucination, outdated knowledge, and nontransparent, untraceable reasoning processes. By incorporating knowledge from external sources and databases, with RAG, users can enable continuous knowledge updates and integration of domain-specific information, especially for knowledge-intensive tasks.

An example RAG process may include operations such as Rewriter, which operates to refine or modify an initial query to improve search effectiveness for documents responsive to a user request. The RAG process may also include a retriever which, given a large repository, efficiently retrieves relevant documents to user queries. Another element of a RAG process is reranking that applies a fine-grained reordering of documents within the retrieved document set, focusing on the quality of document ranking. Finally, a RAG process may include a reader that is able to comprehend real-time user intent and generate dynamic responses based on the retrieved text.

While RAG has proven useful in some circumstances, various problems remain. One of the biggest of these problems is how to choose the best reranking method, since each different algorithm produces a different rank of retrieved sources, or documents.

### BRIEF DESCRIPTION OF THE DRAWINGS

In order to describe the manner in which at least some of the advantages and features of one or more embodiments may be obtained, a more particular description of embodiments will be rendered by reference to specific embodiments thereof which are illustrated in the appended drawings. Understanding that these drawings depict only typical embodiments and are not therefore to be considered to be limiting of the scope of this disclosure, embodiments will be described and explained with additional specificity and detail through the use of the accompanying drawings.

FIG. 1 discloses aspects of an example RAG pipeline.

FIG. 2 discloses aspects of a method, according to one embodiment.

FIG. 3 discloses a procedure (‘Procedure 1’) for generating a best combination of reranking models, according to one embodiment.

FIG. 4 discloses an example individual, or problem solution, representation, according to one embodiment.

FIG. 5 discloses an application of a crossover operation being applied to two individuals, according to one embodiment.

FIG. 6 discloses a step-by-step application of a mutation operator, according to one embodiment.

FIG. 7 discloses operations of a weight optimizer, according to one embodiment.

FIG. 8 discloses aspects of a computing entity configured and operable to perform any of the disclosed methods, processes, and operations.

### DETAILED DESCRIPTION OF SOME EXAMPLE EMBODIMENTS

Embodiments disclosed herein generally relate to identification and retrieval of information, such as in response to user queries. More particularly, at least some embodiments relate to systems, hardware, software, computer-readable media, and methods, for re-ranking documents retrieved, or otherwise obtained, in response to a user query.

One or more example embodiments may comprise a method and mechanism for reranking, using multiple different reranking models, documents or other information retrieved in response to a user query. One embodiment comprises a reranking mechanism that is operable to combine a set of reranking models intelligently in a RRF (Reciprocal Rank Fusion) manner.

An example reranking method may comprise various operations, including: receiving a set of n reranking models R={r₁, r₂, . . . , rₙ} and a dataset D={(q₁, a₁)), (q₂, a₂), . . . , (qⱼ, aⱼ)} composed by j questions q and their expected source documents a for each respective question, such as a question posed by a user; performing a first procedure, using both R and D, to obtain a best combination of reranking models (or simply ‘models’), and then returning the best combination set of models M_{B}; performing a second procedure with respect to M_{B} and D to predict and calculate the best weights for each model, and then returning a weights set W_{B} that corresponds to the best combination set of models; returning M_{B} and W_{B} for use in a RAG pipeline; and, using the RAG pipeline to extract the best answers by using the best set of models and the respective weights for those models.

Embodiments, such as the examples disclosed herein, may be beneficial in a variety of respects. For example, and as will be apparent from the present disclosure, one or more embodiments may provide one or more advantageous and unexpected effects, in any combination, some examples of which are set forth below. It should be noted that such effects are neither intended, nor should be construed, to limit the scope of the claims in any way. It should further be noted that nothing herein should be construed as constituting an essential or indispensable element of any embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, one advantageous aspect of one embodiment is that an embodiment may improve rankings generated by an RAG process by way of an automatic and evolutionary RRF optimization process. An embodiment may automatically define a best possible reranking model for information retrieved in response to a user query. An embodiment may combine multiple different reranking methods in an RRF manner. Various other advantages of one or more example embodiments will be apparent from this disclosure.

### A. References

Reference may be made herein to various documents, which are listed below. These documents are incorporated herein in their respective entireties by this reference.
[1] Gao, Yunfan, et. al. “Retrieval-Augmented Generation for Large Language Models: A Survey”. arXiv preprint arXiv:2312.10997 (2023).
[2] Lewis, Patrick, et al. “Retrieval-augmented generation for knowledge-intensive NLP tasks.” Advances in Neural Information Processing Systems 33 (2020): 9459-9474.
[3] Rokach, L. (2010). “Ensemble-based classifiers”. Artificial Intelligence Review. 33 (1-2): 1-39. doi:10.1007/s10462-009-9124-7. hdl:11323/1748. S2CID 11149239.
[4] Bruch, Sebastian, et. al. “An Analysis of Fusion Functions for Hybrid Retrieval”. arXiv preprint arXiv:2210.11934 (2023).
[5] Hybrid search scoring (RRF)—Azure AI Search|Microsoft Learn. https://learn.microsoft.com/en-us/azure/search/hybrid-search-ranking.
[6] Zhu, Yutao, et al. “Large language models for information retrieval: A survey.” arXiv preprint arXiv:2308.07107 (2023).

### B. Context

The following is a discussion of aspects of a context for various embodiments. This discussion is not intended to limit the scope of the claims or this disclosure, or the applicability of the embodiments, in any way.

### B.1 Large Language Model (LLM)

LLMs are deep learning-based natural language processing models designed to process and understand the human language. These models are often trained on a large and massive set of textual data from diverse sources. Additionally, these models can identify entities and relationships between them and generate new coherent and grammatically accurate text.

There are several potential applications and tasks that LLMs can perform. They are often used for tasks such as answering questions, writing essays, translating text, summarizing documents, generating code in a programming language, among others. They are also used in chatbots, digital assistants and many other applications where text generation or understanding is required.

Although these models demonstrate high capacity for solving the proposed tasks and surprising results, there are challenges and limitations related to them. These include potential biases in the training data, inaccurate or inappropriate content generation, hallucination, outdated knowledge, and nontransparent, untraceable reasoning.

### B.2 Retrieval Augmented Generation (RAG)

LLM shortcomings underscore the impracticality of deploying these models as black-box solutions in real-world production environments without additional safeguards. In this sense, Retrieval-Augmented Generation (RAG) is a promising approach for mitigating many of these constraints, by integrating external data retrieval into the generative process, thereby enhancing the model's ability to provide accurate and relevant responses, incorporating knowledge from external sources and databases. See [1].

RAG was first introduced in [2] and stands as a paradigm within the realm of LLMs, enhancing generative tasks. With RAG, we are able to allow for continuous knowledge updates and integration of domain-specific information, especially for knowledge-intensive tasks. RAG processes involve 4 main steps: rewriter, retriever, reranking and reader.

In the rewriter step of RAG, a main objective is to refine or modify the initial query to improve search effectiveness. By doing this, the system is able to retrieve a collection of documents that align more closely with the information needs of a user, addressing vocabulary mismatches besides refine and adapt system responses based on evolving conversations.

In the retriever phase of RAG, the goal is, given a large repository, to efficiently retrieve relevant documents to user queries. This phase enables a more efficient understanding of query-document relationships, leveraging the power of vector representations to capture semantic similarities.

The third step in RAG is the reranking. In the reranking phase, the objective is to apply a fine-grained reordering of documents within the retrieved document set, focusing on the quality of document ranking. In this case, a reranking model, given a query and document pair, will output a similarity score. This score is then used to reorder the documents according to their relevance to the query, thus proving a retrieve of the most relevant documents for that query. Generally, reranking solutions are based on Bi-Encoders or Cross-Encoders.

In the last step, reader, the goal is to comprehend real-time user intent and generate dynamic responses based on the retrieved text. Instead of presenting a list of documents, the reader module organizes answer texts in a more intuitive manner, simulating the natural way humans access information. The reader can be passive or active. Passive reader provides the retrieved documents according to the queries or previously generated texts as inputs to LLMs for creating the final answer. On the other side, active reader trains LLMs to interact proactively with search engines and seek for information.

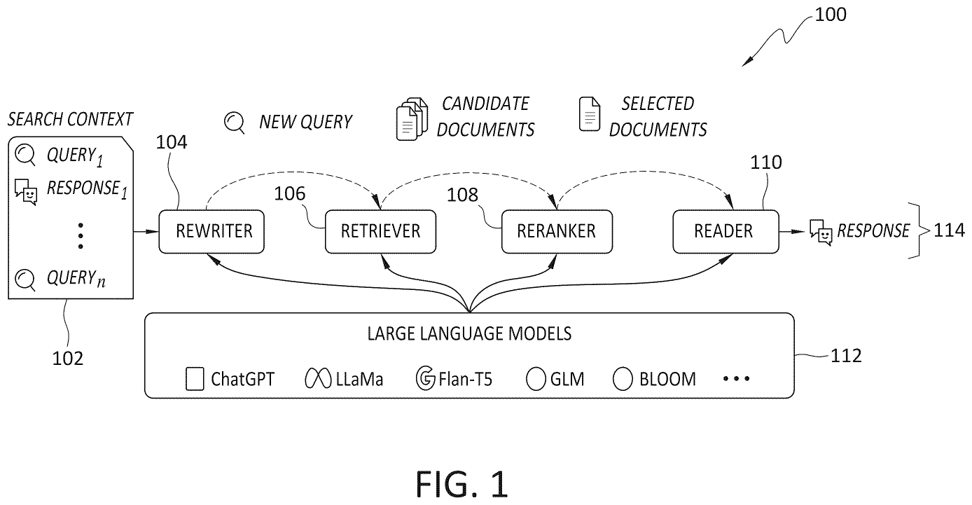

With attention now to FIG. 1, an example of a RAG pipeline is referenced at 100. As shown there, the RAG pipeline 100 is configured to operate on a document query 102 performed in response to a user request for information. The RAG pipeline 100 comprises various modules arranged in serial form, namely, a rewriter 104, retriever 106, re-ranker 108, and reader 110. Any, or all, of these modules may comprise one or more LLMs 112. The output, or response 114, of the RAG pipeline 100 comprises a ranked list of documents that can be returned to the user. Further details concerning a RAG pipeline can be found in [1] and [2].

### B.3 Reciprocal Rank Fusion (RRF)

Reciprocal Rank Fusion (RRF) is a method that evaluates the scores from multiple, previously ranked results to produce a unified result set. RRF has been frequently used to combine results from different search systems in RAG applications. It has been proven to outperform many other documents reranking methods. See [4].

RRF approaches take the search results from multiple methods, assign a score to each document in the results, and then combine the scores to create one unique ranking. It is a non-parametric model that can be used in a zero-shot fashion. See [4]. The intuition behind RRF is that documents appearing in the top positions across multiple search methods tend to be more relevant and should be ranked higher in the combined result. See [5].

### B.4 Genetic Algorithms (GA)

Genetic Algorithms (GAs) are a class of optimization algorithms inspired by the process of natural selection. GAs simulates the process of natural evolution by employing techniques such as selection, crossover (recombination), and mutation to evolve individuals (or solutions to problems). The main parameters of a GA are the population size (define the number of individuals in a population), the crossover rate (probability of combining two individuals forming a new solution to the problem), mutation rate (probability of randomly changing parts of a given solution), and the selection method (how individuals are chosen for reproduction).

The process starts from an initial population of solutions, and then evaluates each individual using a fitness function, that is, a function that evaluates the quality of the solution, apply genetic operators (selection, crossover, and mutation) to generate the next population. The cycle continues until a termination condition is met, such as a maximum number of generations in achieved, or a solution found that has sufficient quality.

### C. Overview of Aspects of One or More Embodiments

### C.1 Introduction

Retrieval-Augmented Generation (RAG) is a promising approach for mitigating many of the LLM challenges and limitations such as hallucination, outdated knowledge, and nontransparent, untraceable reasoning processes. By incorporating knowledge from external sources and databases, with RAG, we are able to allow for continuous knowledge updates and integration of domain-specific information, especially for knowledge-intensive tasks.

As noted earlier herein, RAG processes involve 4 main steps: rewriter, retriever, reranking and reader: rewriter—refine or modify the initial query to improve search effectiveness; retriever—given a large repository, efficiently retrieve relevant documents to user queries; reranking—apply a fine-grained reordering of documents within the retrieved document set, focusing on the quality of document ranking; and, reader—comprehend real-time user intent and generate dynamic responses based on the retrieved text.

Improving the quality of retrieved documents in the retriever step of RAG and, consequently, improving the quality of the response from a LLM is one of the most routine and non-trivial tasks in GenAI applications. One way to improve the quality of the retrieved documents used as context in generating the model's final response is by reranking the sources generated in the retriever step. Reranking the retrieved information to relocate the most relevant content to answer a given query is a key strategy in RAG applications. See [1].

In the reranking step, the RAG pipeline may receive a list of retrieved sources and apply a reranking method to reorder the retrieved sources based on different strategies. As noted above, one of the biggest problems is how to choose the best reranking method, since each different algorithm produces a different rank of retrieved sources.

Thus, an embodiment comprises a method and mechanism to improve RAG applications via automatic selection of reranking models combined in a rank fusion fashion. One example embodiment combines the solutions from more than one retrieval algorithm, by leveraging the rank of the documents to weight an ensemble with responses from more than one reranking model through a Reciprocal Rank Fusion (RRF) fashion. As such, an embodiment may provide various functionalities.

For example, an embodiment may ensure that, when retrieving documents from some given query, the documents are being returned in the best possible order to answer each query. In contrast, conventional reranking approaches are susceptible to failure when reranking documents, given the complexity of the problem. Therefore, in conventional approaches, finding a priori the best reranking model to be used given a query is not a trivial task. An embodiment may automatically combine the solutions of reranking models aiming for a better final ordering. An embodiment may automatically select the best reranking model solution to be used in the RAG framework. An embodiment may combine the best generated solutions into an adapted rank fusion model. In contrast with one or more embodiments, it is noted that while a combination of reranking methods may be a feasible alternative, in some circumstances, defining the best solution for this combination is problematic.

### C.2 Discussion

One embodiment comprises a framework that intelligently combines two or more reranking methods in an RRF fashion. This approach is flexible and enables a user to define how many ranking solutions should be combined to generate the final answer in a way that maximizes the number of target sources retrieved for most cases. Additionally, an embodiment may leverage the reranking models to ensemble them in an RRF fashion aiming to weighted models that perform better in most cases. One example embodiment may work in two steps, or procedures. First, an embodiment may perform a model combination selection method using a genetic algorithm approach. Then, that method may be combined and deployed in production with an adapted RRF ranking.

To find the best solution for a given set of circumstances, an embodiment may proceed as follows:

### Phase 1: Main

1. Receive R={r1, r2, . . . , rn} the set of reranking models.
2. Receive D={(q1, a1)), (q2, a2), . . . , (qj, aj)} a dataset of j pairs of questions q and expected documents a.
3. Send R and D to Generate Best Combination.
   3.1 Return the set containing the best combination models Mb.
4. Apply the Weight Optimizer Model to the dataset D and the best combination from Step 3.1 Mb.
   4.1 Return the weights Wb.
5. Send the set of models Mb and the set of weights Wb to the RAG application.

### Procedure 1: Generate Best Combination of Reranking Models

1. Receive R={r1, r2, . . . , rn} the set of reranking models.
2. Receive D={(q1, a1)), (q2, a2), . . . , (qj, aj)} a dataset of j pairs of questions q and expected documents a.
3. Initiate a population of P individuals
   3.1 Each individual is formed by a vector of N positions, one position for each reranking model.
4. Run the genetic algorithm for K generations or until its convergence is achieved
   4.1 Run the fitness function for each individual in the population.
   4.2 In each run an embodiment may select the top individuals based on a fitness function.
   4.3 Apply the crossover and mutation procedures to generate the next population.
   4.4 Fitness function
      4.4.1 Fitness function receives an individual, that is, a collection of selected reranking models and weights.
      4.4.2 The final weights are used to evaluate the reranking model using the RRF.
   4.5 In the last generation, return the individual with highest fitness score.

### Procedure 2: Weight Optimizer Model

1. Receive D={(q1, a1)), (q2, a2), . . . , (qj, aj)} a dataset of j pairs of questions q and expected documents a.
2. Receive a combination of reranking methods M.
3. Apply a retriever to generate the sources of the answers A.
4. Apply A to the set of reranking methods M.
   4.1 Return the reordered sources for each of the reranking methods AM.
5. Send M and AM to the Weight Model,
6. While the RRF score s is not optimal
   6.1 Apply Weight Model to M and AM
      6.1.1 Return the weight vector WM with a weight for each reranking model in M
   6.2 Send WM to RRF
      6.2.1 Return the score s
      6.2.2 If s is optimal
         6.2.2.1 Return the optimal s* and the current and optimal W*
      6.2.3 If s is not optimal
         6.2.3.1 Return to step 6

As will be apparent from this disclosure, one or more embodiments may possess various useful features and aspects, although no embodiment is required to possess any of such features or aspects. The following examples are illustrative, but not exhaustive. An embodiment may comprise a framework to improve the final quality of reranking in RAG applications through an automatic and evolutionary approach to optimize RRF. An embodiment may implement an evolutionary approach based on genetic algorithms to automatically define the best possible reranking model combination to be used in the RAG framework. An embodiment may comprise a strategy to intelligently combine reranking methods in a RRF fashion.

In contrast with one or more embodiments, and while Reciprocal Rank Fusion (RRF) is a well-known technique in the literature for improving retrieval in Retrieval-Augmented Generation (RAG) applications, the inventors are not aware of any frameworks that apply an evolutionary approach to automatically optimize the RRF solution while minimizing the computation by reducing the number of combined models.

### D. Detailed Discussion of Aspects of One or More Embodiments

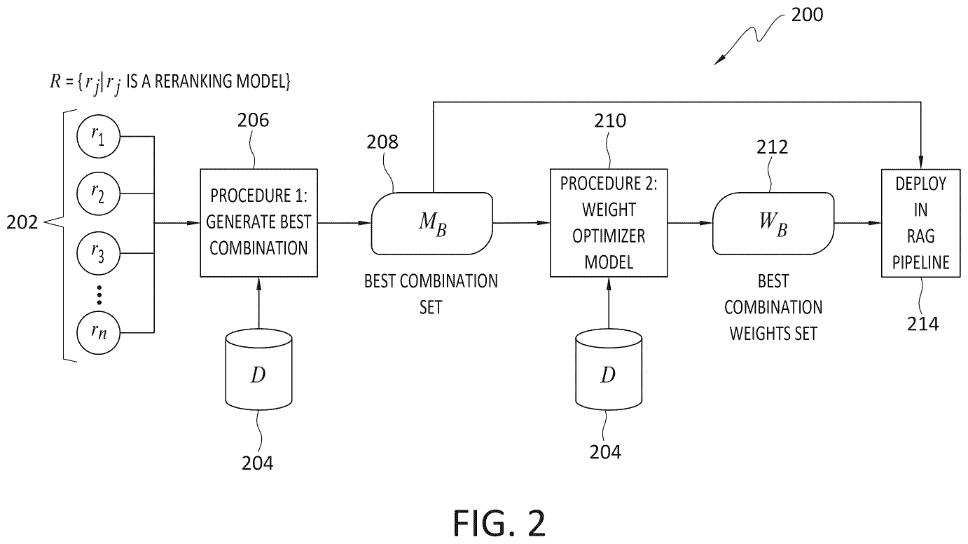

An example embodiment comprises a reranking operation such as may be performed in the context of RAG applications. An embodiment may comprise two procedures applied in a one-phase solution. With attention now to FIG. 2, an overview of an example embodiment of a method 200 is disclosed.

An objective of one embodiment is to provide, and use, a reranking mechanism that combines a set of reranking models intelligently in an RRF fashion. In the first step of one embodiment, two inputs are received, namely, (1) a set 202 of n reranking models R={r1, r2, . . . , rn}, and (2) a dataset 204 D={(q1, a1)), (q2, a2), . . . , (qj, aj)} composed by j questions q and their expected source documents a for each respective question.

Next, both R and D are employed in ‘Procedure 1’ 206 which operates to generate the best combination of models possible in order to identify the best reranking approach as well. The procedure 206 returns the best combination set of models MB 208.

In the third step, and with continued reference to the example of FIG. 2, MB 208 and D 204 are employed in ‘Procedure 2’ 210 in which a Weight Optimizer model uses the selected models generated in ‘Procedure 1’ 206 to predict and calculate the best weights for each model to obtain a balanced approach in the end to the Rank Fusion strategy. The ‘Procedure 2’ 210 returns the best combination weights set WB 212.

In the final step, the system returns MB 208 and WB 212 to be deployed 214 in the RAG pipeline to extract the best answers by using the best set of models and the respective weights for them. Procedures 1 and 2 are discussed in further detail below.

### D.1 Generate Best Combination of Reranking Models

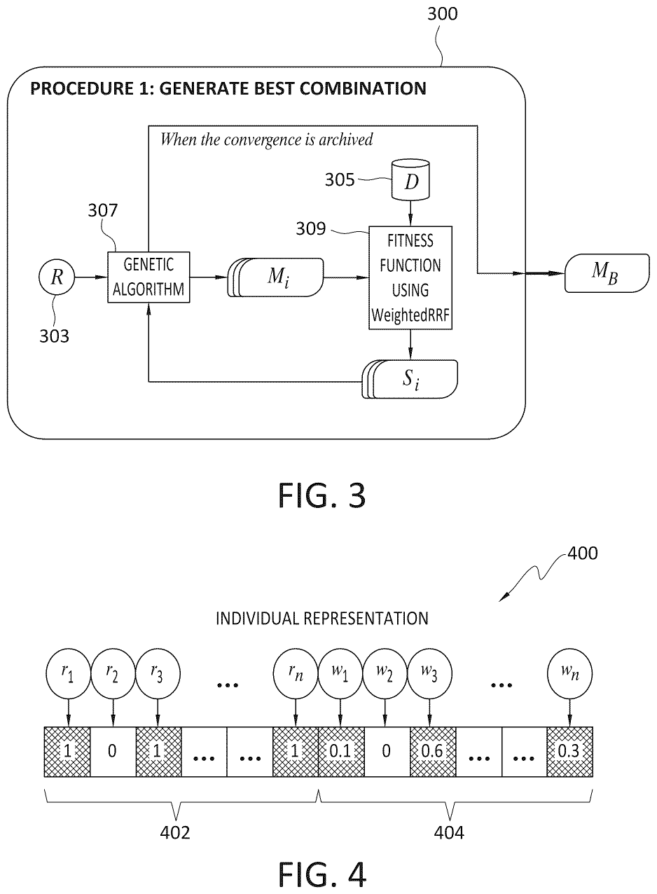

As noted above, an embodiment of ‘Procedure 1’ (denoted at 206 in FIG. 1) operates to generate a best combination of reranking models. To generate the best combination of reranking models, an embodiment may begin by sending a set of reranking models [symbol] and a dataset D to a GA (Genetic Algorithm) optimization procedure. This procedure operates to search for a good combination of reranking models that fits well with the input dataset. An embodiment of a method for ‘Procedure 1’ is indicated at 300 in FIG. 3.

As shown in FIG. 3, the method 300 may begin with receipt of the set of set of reranking models [symbol] 303 and a dataset D 305 of labeled data, as described above. The reranking models [symbol] 303 may be received at a GA 307, and the dataset D 305 received by a fitness function 309.

A first step, after receipt of the reranking models [symbol] 303 and the dataset D 305, may be building an initial population of solutions of size I. Each individual in the population is composed of a vector, referred to as an ‘individual representation’ or simply ‘individual,’ of size 2N, where N is the number of reranking methods available. With reference now to FIG. 4 as well, an example individual representation 400 is disclosed that may be employed in an optimization step of one embodiment of a method. As shown, the first N positions 402 of the individual representation 400 describe whether a given reranking model is selected to be used, and the final N positions 404 represent the weight for a given reranking method in the result. It is noted that even though rank fusion may combine ranking well, that approach still gives each one of the reranking models the same weight, or contribution, to the result, which may not be ideal in all circumstances. Thus, an embodiment may employ weights to overcome this problem.

The initial population size must be greater than the number of greedy possible combinations of reranking models. For example, if there are N reranking models, the population must be greater than 2N−1 individuals. Once the population of individuals is built, we calculate the fitness of each individual using the weight RRF formula, described as:

$$weightedRRF ( doc ) = {\sum }_{( r ∈ R )} {w}_{r} \frac{1}{k + r ( doc )} ,$$

where doc is a document, R is the set of reranking models, k is a constant, and r(doc) is the rank of the document doc in the reranking model r, and wr is the weight of the reranking method r. The fitness is the average result of applying the weighted RRF on every example in the dataset D. After calculating the fitness, an embodiment may apply the genetic operators, that is, (1) selection, (2) crossover, and (3) mutation, in order to generate the next population. These genetic operators are discussed in turn below.

Selection operator: Any GA selection could be used in a method according to one embodiment. One example of an approach that could be used in an embodiment is tournament selection. A tournament may include the following steps: (1) randomly select T individuals from the populations and perform a tournament amongst them; and (2) select the individual with the best fitness from the T individuals—the selected individuals are used in the crossover step; and, (3) repeat until a desirable population size is reached.

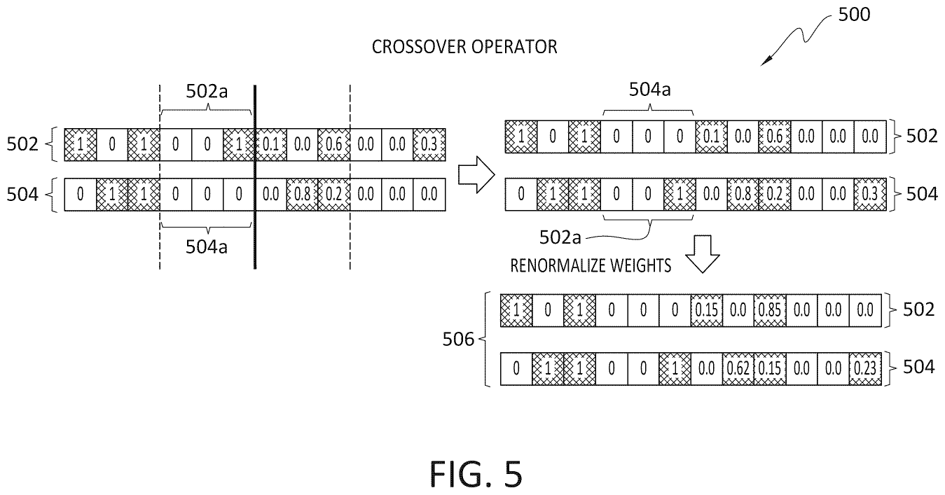

Crossover operator: As discussed in connection with FIG. 4, and with reference now to the example crossover operator 500 disclosed in FIG. 5, disclosing application of a crossover operator to two individuals 502 and 504, an individual in one embodiment may have a two-fold representation, the first part representing the presence or not of a given reranking model, and the second part represent the weight of using the reranking model. In the cross over operation according to one embodiment, each part is crossed individually. Thus, a half 502a/504a of each part is crossed with half 504a/502a of the other part of the pair of selected individuals 502 and 504. Note that after the initial crossover operation, the weights may be unbalanced, so an embodiment may renormalize the weights in the final step, as shown at 506.

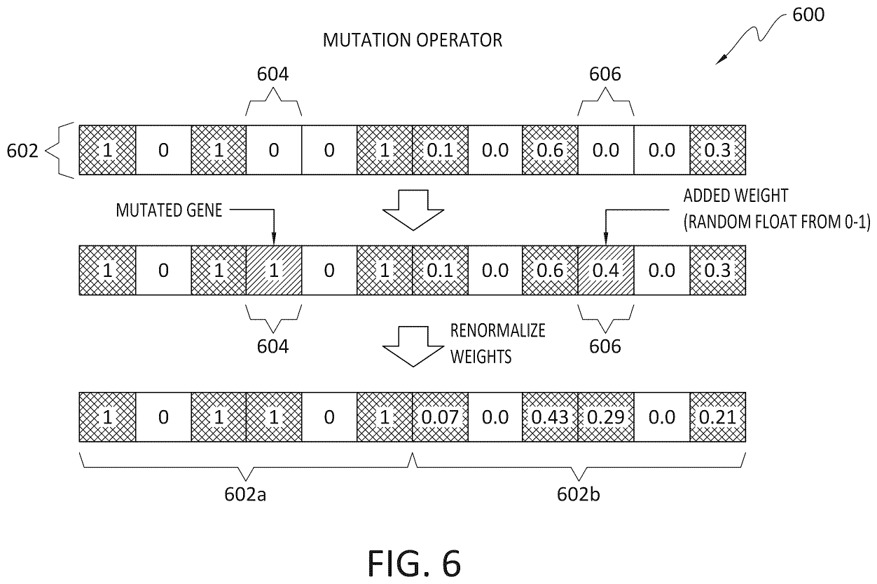

Mutation operator: With reference now FIG. 6, application of an example mutation operator/operation 600 is disclosed. Any mutation operator available for GAs may be used in an embodiment. One embodiment employs a simple operator with mutation rate of mr. A mutation rate mr of 5% means that each gene inside the individual has a probability of 5% of change values. It is only applied on the binary part of the individual and, afterwards, whenever a mutation is applied, an embodiment may run a renormalization step of the weights. Note that, if the mutation is applied to a binary gene from 0 to 1, an embodiment may also provide a weight value for that gene, where the weight value can be obtained by a random number generator and may have a value between 0 and 1. The value will be corrected in the renormalization procedure. FIG. 6 shows the process of applying a mutation operator to an individual.

In more detail, a mutation operator/operation 600 may be applied to an individual 602 with two parts 602a and 602b that represent, respectively, the presence or not of a reranking model, and the weight associated with the reranking model. In FIG. 6, the mutation operator 600 is applied to the gene 604 to change the value of that gene 604 from ‘0’ to ‘1.’ Correspondingly, the weight 606 may be adjusted from 0.0 to another value, 0.4 in the example of FIG. 6. Finally, the weights of part 602b may be renormalized, as shown in FIG. 6.

An embodiment may run the GA for K generations, or until its convergence is achieved. In the last generation, this phase may return the individual, that is, a collection of selected reranking models, with the highest fitness score as defined in FIG. 3 as MB.

### D.2 Weight Optimizer Model

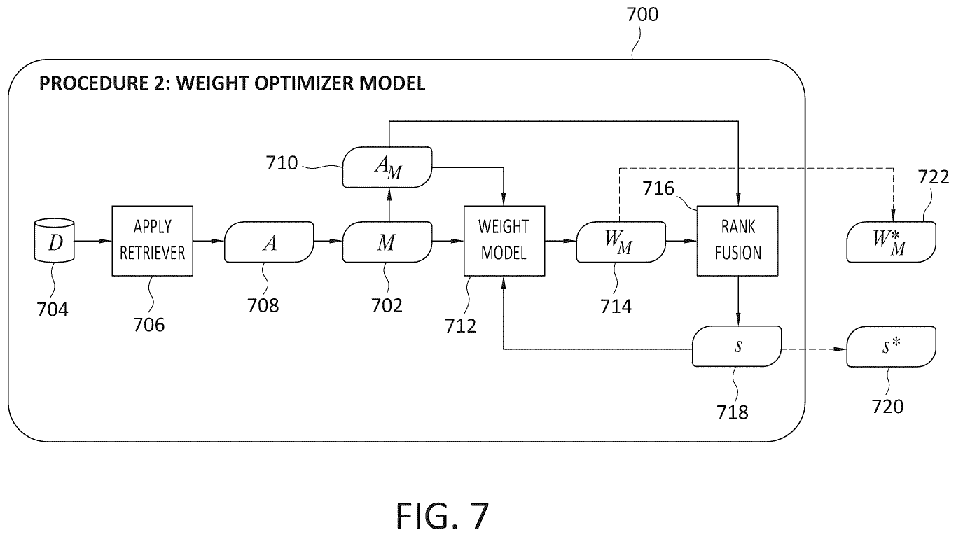

A purpose of the weight optimizer model is to return the best set of weights to be applied to the best combination of reranking models generated in ‘Procedure 1.’ The weights generated by the genetic algorithm are not optimal, since it would take too long to complete the optimization. Thus, one embodiment may use the weights generated in the GA step as warm-start values of the optimization step. In this approach, the optimization step can apply a heavy procedure, to find the best weights on a single combination of reranking models, instead of applying this to the fitness function in the GA which would take much longer to produce satisfying results. FIG. 7 discloses an embodiment of an implementation of ‘Procedure 2,’ referenced as a method 700, in a weight optimizer model.

In particular, as shown in FIG. 7, the method 700 receives a combination of reranking models M 702, such as may be generated by a process such as ‘Procedure 1,’ the GA optimized weights [symbol] ₀ and the dataset [symbol] 704 with a set of questions and their respective expected source documents to be applied to the retriever 706, or step 1 of a RAG pipeline. The retriever 706 returns the answers [symbol] 708 to the questions in dataset [symbol] 704, along with the generated source documents of the answers [symbol] 708.

In the next step, an embodiment may apply each reranking model in M 702 to the generated list of source documents A to reorder the generated source documents according to the reranking model. At the end of this step, an embodiment obtains a set [symbol] 710 of reordered sources [symbol] for the model i in [symbol] .

Next, an embodiment may send the [symbol] 702 and [symbol] 710 to a weight model 712 to generate a weights vector [symbol] 714 with a weight for each reranking model in the reranking models' combination set [symbol] . The weight model can be any machine learning model that returns a set of weights, such as Neural Networks, for example a Multilayer Perceptron (MLP).

An embodiment may then send the reordered sources [symbol] 710 along with the weights vector [symbol] 714 to be applied to the RRF function 716. The RRF function 716 generates a score s 718 that aids an understanding as to how well an embodiment is performing in the task of generating weights for each set of reranking models' combination. An embodiment may repeat this procedure so long as the RRF 716 score s 718 is not optimal. Once an embodiment obtains an optimal score s* 720, it may be returned, followed by the best weights [symbol] 722, at which point the method 700 may conclude.

### E. Example Methods

It is noted that any operation(s) of any of the methods disclosed herein, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other byway of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

### F. Further Example Embodiments

Following are some further example embodiments. These are presented only by way of example and are not intended to limit the scope of this disclosure or the claims in any way.

Embodiment 1. A method for reranking sources retrieved in response to a user query, comprising: receiving a set of reranking models, and a dataset that comprises questions posed by a user, and also comprises expected source documents responsive to the questions; using the set of reranking models, and the dataset, to identify a best combination set of reranking models; using the set of reranking models, and the dataset to determine best respective weights for each of the reranking models; using, in a RAG (retrieval-augmented generation) pipeline, the best combination set of reranking models, and the best respective weights for each of the reranking models, to rank documents, collectively identified by the reranking models, to the questions, and one or more best documents, from among the documents, are ranked highest; and returning the best documents to the user.

Embodiment 2. The method as recited in any preceding embodiment, wherein the documents comprise a set of source documents responsive to the questions posed by the user.

Embodiment 3. The method as recited in any preceding embodiment, wherein respective ranks of the documents are different from an earlier ranking of those documents that was applied to the documents when the documents were initially received.

Embodiment 4. The method as recited in any preceding embodiment, wherein each of the reranking models generates a respective sub-group of the documents that are responsive to the user query.

Embodiment 5. The method as recited in any preceding embodiment, wherein the best combination set of reranking models is identified using a GA (genetic algorithm) optimization procedure.

Embodiment 6. The method as recited in embodiment 5, wherein the GA optimization procedure comprises a group of operators including a selection operator, a crossover operator, and a mutation operator, and the GA optimization procedure runs until the best combination set of reranking models is obtained.

Embodiment 7. The method as recited in any preceding embodiment, wherein the best respective weights are obtained using a weight optimizing process.

Embodiment 8. The method as recited in embodiment 7, wherein the weight optimizing process generates respective weights for each of the reranking models, and the best respective weights generated by the weight optimizing process are more optimal, relative to the weights generated by a GA optimization procedure.

Embodiment 9. The method as recited in embodiment 7, wherein inputs to the weight optimizing process comprise weights generated by a GA optimization procedure, and the dataset.

Embodiment 10. The method as recited in embodiment 7, wherein the weight optimizing process runs until an optimal RRF (reciprocal rank fusion) score is obtained.

Embodiment 11. A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

### G. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of this disclosure also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality. Combinations of the above should also be included within the scope of computer storage media. Such media are also examples of non-transitory storage media, and non-transitory storage media also embraces cloud-based storage systems and structures, although the scope of this disclosure is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments may be downloadable to one or more systems or devices, for example, from a website, mesh topology, or other source. As well, the scope of this disclosure embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, component, client, agent, service, engine, or the like may refer to software objects or routines that execute on the computing system. These may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments may be performed in client-server environments, whether network or local environments, or in any other suitable environment. Suitable operating environments for at least some embodiments include cloud computing environments where one or more of a client, server, or other machine may reside and operate in a cloud environment.

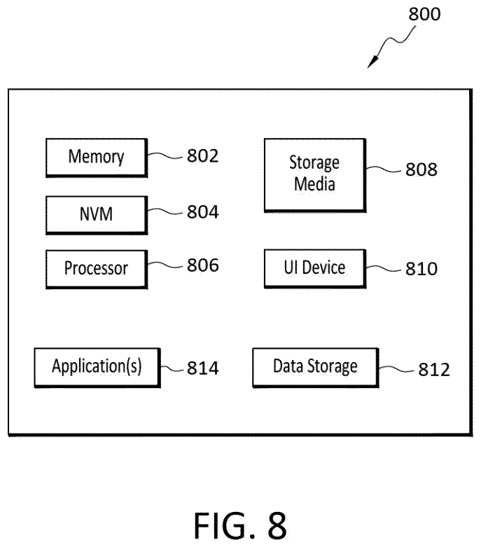

With reference briefly now to FIG. 8, any one or more of the entities disclosed, or implied, by FIGS. 1-7, and/or elsewhere herein, may take the form of, or include, or be implemented on, or hosted by, a physical computing device, one example of which is denoted at 800. As well, where any of the aforementioned elements comprise or consist of a virtual machine (VM), that VM may constitute a virtualization of any combination of the physical components disclosed in FIG. 8.

In the example of FIG. 8, the physical computing device 800 includes a memory 802 which may include one, some, or all, of random access memory (RAM), non-volatile memory (NVM) 804 such as NVRAM for example, read-only memory (ROM), and persistent memory, one or more hardware processors 806, non-transitory storage media 808, UI device 810, and data storage 812. One or more of the memory components 802 of the physical computing device 800 may take the form of solid state device (SSD) storage. As well, one or more applications 814 may be provided that comprise instructions executable by one or more hardware processors 806 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The described embodiments are to be considered in all respects only as illustrative and not restrictive. All changes which come within the meaning and range of equivalency of the claims are to be embraced within their scope.

1. A method for reranking sources retrieved in response to a user query, comprising:
receiving a set of reranking models, and a dataset that comprises a plurality of pairs, each pair comprising a question posed by a user and respective expected source documents responsive to the questions;
running a GA (genetic algorithm) optimization procedure to identify a best combination set of reranking models, the GA optimization procedure comprising:
running a fitness function over each reranking model of the set of reranking models with a respective weight;
in each iteration, selecting top reranking models for the best combination set from the set of reranking model based on highest fitness scores calculated by the fitness function;
performing a crossover procedure and a mutation procedure to non-selected reranking models of the set of reranking models;
normalizing weights of the non-selected reranking models after the crossover procedure and the mutation procedure for a next iteration; and
in a last iteration, return a set of selected reranking models as the best combination set;
running a retriever over the best combination set of reranking models to return answer documents based on the questions in the dataset;
applying each reranking model in the best combination set to reorder respective expected source documents;
optimizing, by a machine learning weight optimizer, a weight of each reranking model to generate a weights vector of the best combination set;
generating, by a reciprocal rank fusion (RRF), a RRF score based on the weights vector until the RRF score meets a predetermined threshold; and
returning best documents to the user based on the best combination set of the reranking models, which has the RRF score, which meets the predetermined threshold, and a corresponding weights vector.

2. The method as recited in claim 1, wherein the documents comprise a set of source documents responsive to the questions posed by the user.

3. The method as recited in claim 1, wherein respective ranks of the documents are different from an earlier ranking of those documents that was applied to the documents when the documents were initially received.

4. The method as recited in claim 1, wherein each of the reranking models generates a respective sub-group of the documents that are responsive to the user query.

5. (canceled)

6. (canceled)

7. The method as recited in claim 1, wherein the best respective weights are obtained using a weight optimizing process.

8. The method as recited in claim 7, wherein the weight optimizing process generates respective weights for each of the reranking models, and the best respective weights generated by the weight optimizing process are more optimal, relative to the weights generated by the GA optimization procedure.

9. The method as recited in claim 7, wherein inputs to the weight optimizing process comprise weights generated by the GA optimization procedure, and the dataset.

10. The method as recited in claim 7, wherein the weight optimizing process runs until an optimal RRF score, which meets the predetermined threshold, is obtained.

11. A non-transitory storage medium having stored therein instructions that are executable by one or more hardware processors to perform operations for reranking sources retrieved in response to a user query, the operations comprising:
receiving a set of reranking models, and a dataset that comprises a plurality of pairs, each pair comprising a question posed by a user, and respective expected source documents responsive to the question;
running a GA (genetic algorithm) optimization procedure to identify a best combination set of reranking models, the GA optimization procedure comprising:
running a fitness function over each reranking model of the set of reranking models with a respective weight;
in each iteration, selecting top reranking models for the best combination set from the set of reranking model based on highest fitness scores calculated by the fitness function;
performing a crossover procedure and a mutation procedure to non-selected reranking models of the set of reranking models;
normalizing weights of the non-selected reranking models after the crossover procedure and the mutation procedure for a next iteration; and
in a last iteration, return a set of selected reranking models as the best combination set;
running a retriever over the best combination set of reranking models to return answer documents based on the questions in the dataset;
applying each reranking model in the best combination set to reorder respective expected source documents;
optimizing, by a machine learning weight optimizer, a weight of each reranking model to generate a weights vector of the best combination set;
generating, by a reciprocal rank fusion (RRF), a RRF score based on the weights vector until the RRF score meets a predetermined threshold; and
returning best documents to the user based on the best combination set of the reranking models, which has the RRF score, which meets the predetermined threshold, and a corresponding weights vector.

12. The non-transitory storage medium as recited in claim 11, wherein the documents comprise a set of source documents responsive to the questions posed by the user.

13. The non-transitory storage medium as recited in claim 11, wherein respective ranks of the documents are different from an earlier ranking of those documents that was applied to the documents when the documents were initially received.

14. The non-transitory storage medium as recited in claim 11, wherein each of the reranking models generates a respective sub-group of the documents that are responsive to the user query.

15. (canceled)

16. (canceled)

17. The non-transitory storage medium as recited in claim 11, wherein the best respective weights are obtained using a weight optimizing process.

18. The non-transitory storage medium as recited in claim 17, wherein the weight optimizing process generates respective weights for each of the reranking models, and the best respective weights generated by the weight optimizing process are more optimal, relative to the weights generated by the GA optimization procedure.

19. The non-transitory storage medium as recited in claim 17, wherein inputs to the weight optimizing process comprise weights generated by the GA optimization procedure, and the dataset.

20. The non-transitory storage medium as recited in claim 17, wherein the weight optimizing process runs until an optimal RRF score, which meets the predetermined threshold, is obtained.
